(19) United States
(12) Patent Application Publication
(10) Pub. No.: US 2010/0122490 A1
(43) Pub. Date: May 20, 2010

(54) APPARATUS FOR SHIELDING PLANTS FROM ADVERSE WEATHER CONDITIONS

(76) Inventors: Paula Stewart, Clearwater, FL (US); Jonathon Seniw, Clearwater, FL (US)

Correspondence Address: L.C. BEGIN & ASSOCIATES, PLLC, 510 HIGHLAND AVENUE, PMB 403, MILFORD, MI, 48381, US

(21) Appl. No.: 12/565,794

(22) Filed: Sep. 24, 2009

Related U.S. Application Data
(60) Provisional application No. 61/115,638, filed on Nov. 18, 2008.

(51) Int. Cl. A01G 13/02

(52) U.S. Cl. 47/29.5

(57) ABSTRACT

An apparatus for shielding plants from adverse weather conditions includes a pair of telescopic elongated members, a pair of supporting members, and a shade member mountable on the pair of supporting members. Each of the pair of supporting members is disposed on a top end portion of a telescopic elongated member of the pair of telescopic elongated members. The shade member is capable of assuming an expanded configuration and a contracted configuration. In the expanded configuration, the shade member is adapted to cover a plant lying adjacent the pair of telescopic members to shield the plant from the adverse weather conditions. In the contracted configuration, the shade member is adapted to uncover the plant.

### CROSS-REFERENCE TO RELATED APPLICATIONS

The present disclosure claims priority under 35 United States Code, Section 119 from the U.S. Provisional Patent Application numbered 61/115,638 filed on Nov. 18, 2008 the disclosure of which is incorporated herein by reference.

### FIELD OF THE DISCLOSURE

The present disclosure generally relates to apparatuses for protection of plants, and more particularly, to apparatuses for shielding plants from adverse weather conditions.

### BACKGROUND OF THE DISCLOSURE

Many people use outdoor potted plants on entranceways of their homes, stairs, near windows, and the like for decorative purposes. The outdoor potted plants relates to plants that are planted and grown in containers, such as plant pots. Such potted plants need to be properly watered for protecting against damage, such as wilting, and the like. However, proper watering may not be the only requirement to prevent the outdoor potted plants from damage. The potted plants often require further protection from adverse weather conditions, such as intense sunlight, frost, heavy rain, and the like.

To shield such potted plants from the adverse weather conditions, people tend to move the potted plants under shelter or shade. Further, in normal weather conditions, the potted plants may be shifted back to their initial locations for providing necessary sunlight to the potted plants. Such frequent shifting of the potted plants requires considerable effort from people and consumes time, and may result in damage to the potted plants in the process of shifting.

Alternatively, such potted plants may be covered with a waterproof canvas for shielding the potted plants against the adverse weather conditions. However, covering the potted plants with the waterproof canvas still consumes time and may be aesthetically unappealing.

Further, people also grow plants directly in ground soil instead of the potted plants. Such plants may also get damaged during the adverse weather conditions. In such a case, a ground cover may be utilized for shielding the plants against the adverse weather conditions. However, covering the ground with the ground cover may also require considerable effort from people and consumes additional time.

Furthermore, when attempting to germinate a new seed, special growing conditions may be required. That is, a seedling may require a high humidity environment, similar to that of a greenhouse, as well as protection from adverse weather conditions.

Accordingly, there exists a need for shielding plants from adverse weather conditions in a manner that is easy and saves time. Specifically, there exists a need for shielding both outdoor potted plants and plants that are grown in ground from the adverse weather conditions in a manner that is easy and saves time. Further, there exists a need for shielding plants from adverse weather conditions in a manner that provides an aesthetically pleasing appearance. Furthermore, there exists a need for shielding seedlings such that the proper growing environment is created and further shielding seedlings from adverse weather conditions.

### SUMMARY OF THE DISCLOSURE

In view of the foregoing disadvantages inherent in the prior art, the general purpose of the present disclosure is to provide an apparatus for shielding plants from adverse weather conditions, configured to include all the advantages of the prior art, and to overcome the drawbacks inherent therein.

Therefore, an object of the present disclosure is to shield plants from adverse weather conditions in a manner that is easy and saves time. Specifically, there exists a need to shield outdoor potted plants and plants that are grown in ground against the adverse weather conditions in a manner that is easy and saves time.

Another object of the present disclosure is to shield plants from adverse weather conditions in a manner that provides an aesthetic appearance to the shielded plants.

Yet another object of the present disclosure is to enclose seedlings during their growth process to aide in germination of the seedling.

To achieve the above objects, in an aspect of the present disclosure, an apparatus for shielding plants from adverse weather conditions is provided. The apparatus includes a pair of telescopic elongated members, a pair of supporting members, and a shade member. Each of the pair of supporting members is disposed on a top end portion of a telescopic elongated member of the pair of telescopic elongated members. Further, the shade member is capable of assuming an expanded configuration and a contracted configuration. In the expanded configuration, the shade member is adapted to cover a plant generally lying between the pair of telescopic members to shield the plant from the adverse weather conditions. In the contracted configuration, the shade member is adapted to uncover the plant.

This together with other aspects of the present disclosure, along with the various features of novelty that characterize the present disclosure, is pointed out with particularity in the claims annexed hereto and form a part of this present disclosure. For a better understanding of the present disclosure, its operating advantages, and the specific objects attained by its uses, reference should be made to the accompanying drawings and descriptive matter in which there are illustrated exemplary embodiments of the present disclosure.

### BRIEF DESCRIPTION OF THE DRAWINGS

The advantages and features of the present disclosure will become better understood with reference to the following detailed description and claims taken in conjunction with the accompanying drawings, wherein like elements are identified with like symbols, and in which:

FIG. 1A depicts a perspective view of an apparatus for shielding plants from adverse weather conditions in an expanded configuration, in accordance with an embodiment of the present disclosure;

FIG. 1B depicts a perspective view of the apparatus of FIG. 1A in a contracted configuration, in accordance with an embodiment of the present disclosure;

FIG. 2 depicts a perspective view of the apparatus of FIG. 1A with a pair of telescopic elongated members in extended configuration, in accordance with an embodiment of the present disclosure; and

FIG. 3 depicts a side view of an apparatus for shielding plants from adverse weather conditions, in accordance with another embodiment of the present disclosure;

Like reference numerals refer to like parts throughout the description of several views of the drawings.

### DETAILED DESCRIPTION OF THE DISCLOSURE

The exemplary embodiments described herein detail for illustrative purposes are subject to many variations in structure and design. It should be emphasized, however, that the present disclosure is not limited to a particular apparatus for shielding plants from adverse weather conditions, as shown and described. It is understood that various omissions and substitutions of equivalents are contemplated as circumstances may suggest or render expedient, but these are intended to cover the application or implementation without departing from the spirit or scope of the claims of the present disclosure. Also, it is to be understood that the phraseology and terminology used herein is for the purpose of description and should not be regarded as limiting. The use of terms, “including,” or “comprising,” and variations thereof herein is meant to encompass the items listed thereafter and equivalents thereof as well as additional items.

The terms “a” and “an” herein do not denote a limitation of quantity, but rather denote the presence of at least one of the referenced item.

Unless limited otherwise, the terms “mounted,” and variations thereof herein are used broadly and encompass direct and indirect attachments and arrangements. The terms, “top,” “bottom,” and the like, herein do not denote any order, elevation or importance, but rather are used to distinguish placement of one element over another.

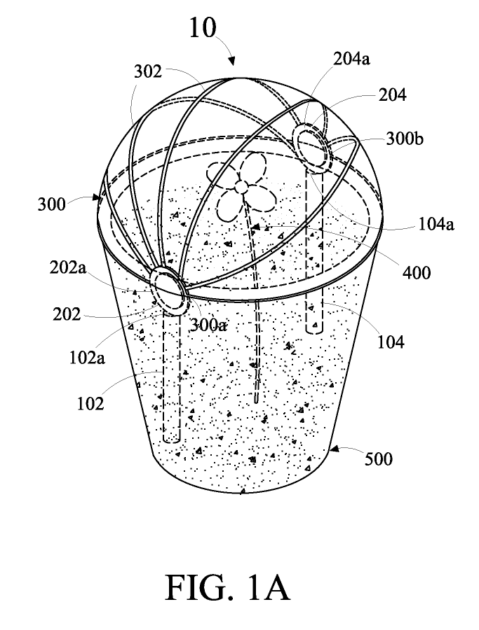

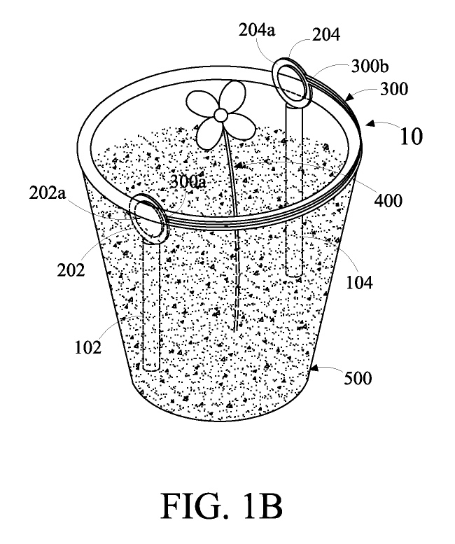

The present disclosure provides an apparatus for shielding plants from adverse weather conditions. The term, “plants” as used herein relates to outdoor potted plants and plants that are grown in ground. Further, herein the term “Plants” also may include seedlings during their growth process. Further, the term, “adverse weather conditions” relates to extreme hot and cold conditions, intense sunlight, heavy rain, frost, and the like. Specifically, the apparatus of the present disclosure is capable of assuming an expanded configuration to cover the plants for shielding the plants from the adverse weather conditions. Further, the apparatus is capable of assuming a contracted configuration for uncovering the plants in the absence of the adverse weather conditions. The apparatus of the present disclosure is explained in detail in conjunction with FIGS. 1A, 1B, 2, and 3.

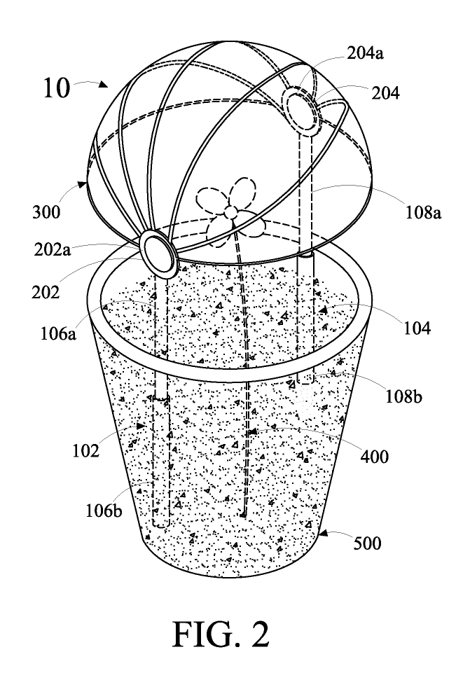

FIG. 1A depicts a perspective view of an apparatus 10 in an expanded configuration, in accordance with an embodiment of the present disclosure. FIG. 1B depicts a perspective view of the apparatus 10 in a contracted configuration, in accordance with an embodiment of the present disclosure. FIG. 2 depicts a perspective view of the apparatus 10 with a pair of telescopic elongated members in an extended configuration, in accordance with an embodiment of the present disclosure. The apparatus 10 is utilized to shield a plant 400 kept in a planter 500 from the adverse weather conditions. The planter 500 is a container wherein plants are planted and grown. In exemplary representations of FIGS. 1A, 1B and 2, various components of the apparatus 10 and other elements such as a plant 400 and the planter 500 are shown as transparent for the sake of clarity of such components, and their description thereof, and it should not be considered limiting.

The apparatus 10 includes a pair of telescopic elongated members a pair of supporting members, and a shade member (as shown in FIGS. 1A, 1B, and 2). The pair of telescopic elongated members includes a telescopic elongated member 102, and a telescopic elongated member 104. A plant 400 may be grown adjacent the telescopic elongated members 102 and 104 placed in a spaced apart relation. In this embodiment, the telescopic elongated members 102 and 104 are fixedly attached on a base member (not numbered) of the planter 500 (as shown in FIGS. 1A, 1B, and 2). Alternatively, the telescopic elongated members 102 and 104 may be fixedly attached to peripheral walls (not numbered) of the planter 500. Further, it will be evident to a person skilled in the art that the telescopic elongated members 102 and 104 are fixedly attached to the planter 500 by suitable means known in the art, such as by welding, adhesion, or molded as a part of the planter 500. The pair of supporting members, such as a supporting member 202 and a supporting member 204 are disposed on top end portions of the telescopic elongated members 102 and 104. Specifically, the supporting member 202 is disposed on a top end portion 102a of the telescopic elongated member 102, and the supporting member 204 is disposed on a top end portion 104a of the telescopic elongated member 104. It will be evident to a person skilled in the art that the supporting members 202 and 204 may be disposed on top end portion 102a and 104a, respectively, by any suitable means known in the art, such as molding, welding, fasteners, and the like.

Each of the supporting members 202 and 204 has an annular periphery, for example, the supporting member 202 includes an annular periphery 202a, and the supporting member 204 includes an annular periphery 204a. A shade member, such as the shade member 300 is mounted on the supporting members 202 and 204. Specifically, the shade member 300 is rotatably mounted on the annular peripheries 202a and 204a of the supporting members 202 and 204, respectively. More specifically, a peripheral edge portion 300a of the shade member 300 may be mounted on a portion of the annular periphery 202a of the supporting member 202. Further, a peripheral edge portion 300b of the shade member 300 may be mounted on a portion of the annular periphery 204a of the supporting member 204. Furthermore, it will be evident to a person skilled in the art that the shade member 300 may be mounted on the supporting members 202 and 204 by any suitable means known in the art.

In one embodiment of the present disclosure, the shade member 300 includes a plurality of longitudinally extending bands 302 abuttingly coupled to each other. The longitudinally extending bands 302 of the shade member 300 are adapted to rotate over the annular peripheries 202a and 204a of the supporting members 202 and 204, respectively. The shade member 300 is capable of assuming an expanded configuration (as shown in FIGS. 1A and 2) and a contracted configuration (as shown in FIG. 1B). In the expanded configuration, the longitudinally extending bands 302 are spread over the annular peripheries 202a and 204b and the shade member 300 is adapted to cover the plant 400 to shield the plant 400 from the adverse weather conditions. In the contracted configuration, each longitudinally extending band of the longitudinally extending band 302 collapse over one another, thereby uncovering the plant 400 as shown in FIG. 1B.

Further, as shown in FIG. 2, the telescopic elongated members 102 and 104 are capable of being adjusted in their heights in accordance with height of the plant 400. Specifically, the telescopic elongated member 102 includes telescopic portions 106a and 106b, and the telescopic elongated member 104 includes telescopic portions 108a and 108b. The telescopic portion 106b has a larger diameter than the telescopic portion 106a and similarly the telescopic portion 108b has a larger diameter than the telescopic portion 108a. Accordingly, the telescopic portions 106a and 108a are capable of sliding within and out of the telescopic portions 106b and 108b, respectively, thereby adjusting the height of the telescopic elongated members 102 and 104, in accordance with the height of the plant 400. It will be evident to a person skilled in the art that although the preferred embodiment discloses only one pair of telescopic portion per side 106a, 106b, 108a, 108b, additional members may be added as necessary.

To shield the plant 400, the longitudinally extending bands 302 may be spread over the annular peripheries 202a and 204a of the supporting members 202 and 204, such that the shade member 300 assumes the expanded configuration. Accordingly, the shade member 300 covers the plant 400 in order to shield the plant 400 from the adverse weather conditions.

Further, in normal weather conditions, i.e., in the absence of the adverse weather conditions, the longitudinally extending bands 302 are collapsed on each other such that the shade member 300 assumes the contracted configuration. In the contracted configuration, shade member 300 uncovers the plant 400 thereby exposing the plant 400 to the normal weather conditions.

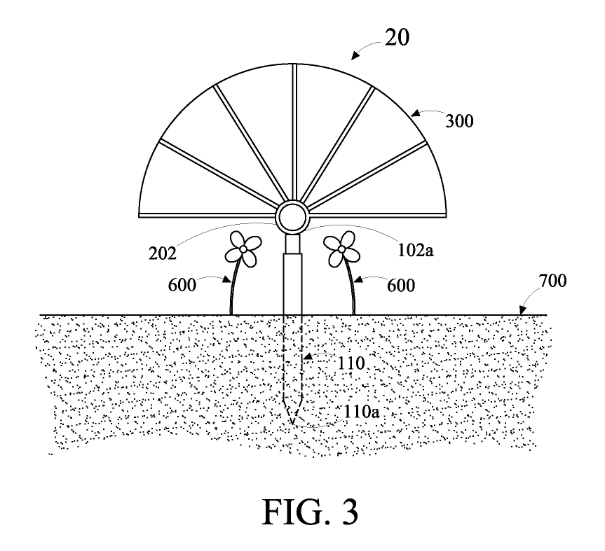

FIG. 3 depicts a side view of an apparatus 20 for shielding plants 600 that are grown in soil 700 from adverse weather conditions, in accordance with another embodiment of the present disclosure. In the present embodiment of the disclosure, the apparatus 20 includes a pair of telescopic elongated members 110, a pair of supporting members such as the pair of supporting members 202 and a shade member such as the shade member 300. Each of the pair of telescopic elongated members 110 includes a pointed bottom end portion 110a. The pointed bottom end portion 110a facilitates a user in securing each of the telescopic elongated members 110 in the soil 700. Once each of the telescopic elongated embers 110 is anchored in the soil 700 adjacent the plants 600, the shade member 300 may be configured to assume the expanded configuration to cover the plants 600, thereby shielding the plants 600 from the adverse weather conditions. Further, in the absence of the adverse weather conditions, the shade member 300 may be contracted to uncover the plant 600.

It will be evident to a person skilled in the art that though FIGS. 1A, 1B, 2 and 3 depict particular shapes and sizes of the telescopic elongated members 102 and 104, or 110, the supporting members 202 and 204, and the shade member 300, however the telescopic elongated members 102 and 104, or 110, the supporting members 202 and 204, and the shade member 300 may be of any other suitable shapes and sizes.

Further, various components of the apparatuses 10 and 20 may be composed of a plastic material, a metallic material, a canvas, or any combination thereof. Specifically, the telescopic elongated members 102, 104 and 110, and the supporting members 202 and 204, may be composed of one of a plastic material including polyethylene and the like, and a metallic material including aluminum and the like. Further, the shade member 300 may be composed of a canvas. Alternatively, the shade member 300 may be composed of a plastic material such as polyethylene, and the like.

The present disclosure provides an apparatus for shielding plants grown in the planter from adverse weather conditions, such as the apparatus 10, in an embodiment of the disclosure. The shade member of the apparatus is capable of assuming an expanded position for covering the plant and a contracted configuration for uncovering the plant. Accordingly, the apparatus shields the plant in a manner which precludes the need of continuous shifting of the plant in and out of a shade. Further, the apparatus provides aesthetically appealing appearance to the plant.

The present disclosure also provides an apparatus for shielding plants grown in ground from adverse weather conditions, such as the apparatus 20, in another embodiment of the present disclosure, which is easy to set up and is portable. The apparatus may be easily carried and set up in the ground easily and in a quick manner. Further, the apparatus provide aesthetically appealing appearance to the plant. Furthermore, the apparatus may shield the seedlings, thereby creating a greenhouse effect to aid in their growth process.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, and to thereby enable others skilled in the art to best utilize the present disclosure and various embodiments with various modifications as are suited to the particular use contemplated. It is understood that various omissions and substitutions of equivalents are contemplated as circumstances may suggest or render expedient, but such omissions and substitutions are intended to cover the application or implementation without departing from the spirit or scope of the claims of the present disclosure.

What is claimed is:

1. An apparatus for shielding plants from adverse weather conditions, said apparatus comprising:
a pair of telescopic elongated members;
a pair of supporting members, each of said pair of supporting members disposed on a top end portion of a telescopic elongated member of said pair of telescopic elongated members; and
a shade member mountable on said pair of supporting members, said shade member capable of assuming an expanded configuration and a contracted configuration, said shade member adapted to cover a plant adjacent the pair of elongated telescopic members in said expanded position to shield the plant from adverse weather conditions, said shade member adapted to uncover the plant in said contracted configuration.

2. The apparatus of claim 1, wherein the pair of telescopic elongated members is fixedly attached to a planter.

3. The apparatus of claim 1, wherein each of the pair of telescopic elongated members includes a pointed bottom end portion.

4. The apparatus of claim 3, wherein the pointed bottom end portion of each of the telescopic elongated member is capable of being anchored in soil adjacent a plant.

5. The apparatus of claim 1, wherein each of said pair of supporting members has an annular periphery, and wherein said shade member is rotateably mounted on said annular periphery of each of said pair of supporting members to assume one of said expanded configuration and said contracted configuration.

6. The apparatus of claim 5, wherein said shade member comprises a plurality of longitudinally extending bands abuttingly coupled to each other.

7. The apparatus of claim 1, wherein each telescopic elongated member of said pair of telescopic elongated members is composed of one of a plastic material and a metallic material.

8. The apparatus of claim 1, wherein each supporting member of said pair of supporting members is composed of one of a plastic material and a metallic material.

9. The apparatus of claim 1, wherein said shade member is composed of a canvas material.

10. The apparatus of claim 1, wherein said shade member is composed of a plastic material.
